(19) United States
(12) Patent Application Publication
(10) Pub. No.: US 2007/0219778 A1
(43) Pub. Date: Sep. 20, 2007

(54) Speech processing system

(75) Inventors: Stephen Whittaker, Sheffield (GB); Simon Tucker, Sheffield (GB)

Correspondence Address: WILMER CUTLER PICKERING HALE AND DORR LLP, 60 STATE STREET, BOSTON, MA, 02109, US

(73) Assignee: University of Sheffield, Sheffield (GB)

(21) Appl. No.: 11/385,027

(22) Filed: Mar. 20, 2006

Related U.S. Application Data
(60) Provisional application No. 60/783,235, filed on Mar. 17, 2006.

(51) Int. Cl. G06F 17/27

(52) U.S. Cl. 704/9

(57) ABSTRACT

Embodiments of the present invention relate to a speech processing system comprising a data base manager to access a speech corpus comprising a plurality of sets of speech data; means for processing a selectable set of speech data to produce correlated redundancy data and means for creating a speech file comprising speech data according to the correlated redundancy data having a playback speed other than the normal playback speed of the selected speech data.

### CROSS REFERENCE TO RELATED APPLICATION

This application claims priority from the provisional patent application Ser. No. ______, filed Mar. 17, 2006, entitled SPEECH PROCESSING SYSTEM, which is incorporated herein by reference.

### FIELD OF THE INVENTION

Embodiments of the present invention relate to a speech processing system.

### BACKGROUND TO THE INVENTION

Speech is an expressive, ubiquitous, and easy to produce form of communication as compared with text as can be appreciated from, for example, “Expressive Richness: A comparison of speech and text as media for revision”, Chalfonte, B. L., Fish, R. S. and Kraut, R., Proc. CHI 1991, 21-26. Furthermore, as the cost of digital storage decreases, large speech archives are becoming available for different speech genres including meetings (Morgan N., Baron D., Edwards J., Ellis D., Gelbart D., Janin A., Pfau,T., Shriberg, E., Stolcke, H., The meeting project at ICSI, Proc. HLT Conference, (2001), 246-252), news (Voohees, E. M. and Buckland, L. P. The Thirteenth Text Retrieval Conference Proceedings. NIST Special Publication, (2004)), voice mail (Whittaker, S., Hirschberg, J., Amento, B., Stark, L., Bacchiani, M., Isenhour, P., Stead, L., Zamchick, G. and Rosenberg, A. SCANMail: A voicemail interface that makes speech browsable, readable and searchable. In Proc. CHI 2002, (2202), 275-282) and conference presentations (MLMI 2005. http://groups.inf.ed.ac.uk/mlmi05/techprog.html.). However, the lack of good end-user tools for searching and browsing speech makes it tedious to extract infomation from these archives.

Recent research has begun to develop such end-tools. For example, numerous projects have developed visual interfaces that allow users to browse meeting records using various indices such as speaker, topic, visual scene changes, user notes or slide changes as can be appreciated from, for example, Cutler, R., Rui, Y., Guputa, A. Cadiz, J. J. Tashev, I., He, L., Colburn, A., Zhang, Z., Liu, Z. and Silverberg, S. Distributed meetings: A meeting capture and broadcasting system. Proc. 10^{th} ACM International Conf on Multimedia, (2002), 503-512, Morgan, N., Baron D., Edwards, J., Ellis, D., Gerbart, D., Janin, A., Pfau, T., Shriberg, E. and Stolcke, A. The meeting project at ICSI. Proc. HLT Conference, (2001), 246-252, Stifelman, L. Augmenting real-world objects: A paper-based audio notebook. In Proc. CHI 1996, (1996), 199-200 and Tucker, S. and Whittaker, S. Accessing multimodal meeting data: systems, problems and possibilities. in Lecture Notes in Computer Science 3361, (2005), 1-11. Other research has developed methods that allow users to browse and search transcript-centric presentations derived by applying automatic speech recognition (ASR) to the recordings. All papers cited herein are incorporated by reference for all purposes.

However, a limitation of these tools is that they make use of feature-rich visual displays to show complex representations of speakers, ASR transcripts, documents, whiteboards, video and slides etc. While these devices may be suitable for use, for example, within an office environment, they are less useful within a mobile environment in which simpler communication devices such as, for example, mobile telephones or PDAs are used.

It is an object of embodiment of the present invention to at least mitigate one a more problems of the prior art.

### SUMMARY OF THE INVENTION

Accordingly, embodiments of the present invention provide a system as claimed in claim 1.

Advantageously, embodiments of the present invention support end-user searching and browsing of a speech corpus. Preferably, this advantage can be realised even using relatively unsophisticated devices such as, for example, mobile telephones or PDAs. Embodiments and, in particular, support aural searching and browsing of the speech corpus.

Other aspects of embodiments of the present invention are described herein and defined in the remaining claims.

### BRIEF DESCRIPTION OF THE DRAWINGS

Embodiments of the present invention will now be described by way of example only with reference to the accompanying drawings in which

FIG. 1 shows a speech processing arrangement comprising a speech processing system according to an embodiment;

FIG. 2 depicts a speech processing algorithm according to a first embodiment;

FIG. 3 illustrates a speech processing algorithm according to a second embodiment;

FIG. 4 shows a speech processing algorithm according to a third embodiment;

FIG. 5 depicts a speech processing algorithm according to a fourth embodiment;

FIG. 6 illustrates a speech processing algorithm according to a fifth embodiment;

FIG. 7 shows a speech processing algorithm according to a sixth embodiment; and

FIGS. 8 and 9 shows processes for constructing a speech file according to embodiments.

### DESCRIPTION OF PREFERRED EMBODIMENTS

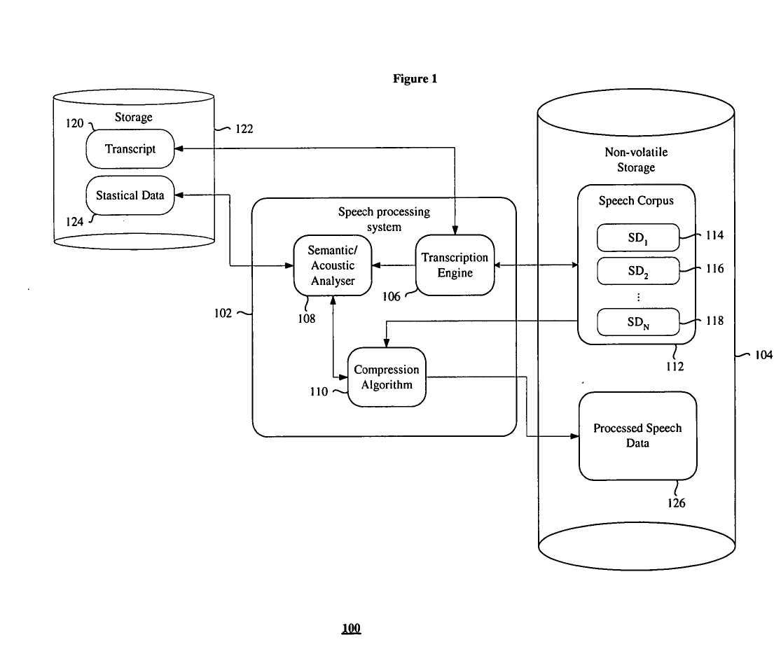

Referring to FIG. 1, there is shown a speech processing arrangement 100 comprising a speech processing system 102 according to an embodiment of the present invention and non-volatile storage 104. The speech processing system 102 comprises a transcription engine 106, a semantic/acoustic analyser 108 and a compression algorithm 110. The non-volatile storage 104 is arranged to store a speech corpus 112 comprising a number of sets or bodies of speech 114, 116 and 118. The bodies of the speech 114 to 118 may represent any recorded speech data such as, for example, a presentation, a teleconference, a meeting, a conversation or any other form of speech.

The transcription engine 106 is arranged to process the speech data 114 to 118 or, more accurately, at least a selectable one of the speech data 114 to 118, to produce at least one corresponding transcript 120 that is also stored using some form of storage 122 for later use by the semantic/acoustic analyser 108. The transcription engine transcribes the speech data 114 to 118 or the selected set of speech data to produce corresponding text of the transcript 120.

The semantic/acoustic analyser 108 analyses the transcript 120 to produce statistical data 124 relating to the words, clauses, phrases, sentences, paragraphs or other functional units of text or speech. Preferably, that statistical data comprises data relating to the number of occurrences of each functional unit.

The compression algorithm 110 uses the results of the semantic/acoustic analyser 108 to produce processed speech data 126. Preferably, the processed speech data 126 takes the form of compressed speech data in preferred embodiments such that the compressed speech data 126 has a shorter (or faster) playback time relative to the speech data 114 to 118 from which it was derived while still allowing an acceptable measure of comprehension so that a user can at least usefully search through or browse the speech data by at least determining the gist of the speech data. Embodiments of the compression algorithm 110 are described in greater detail below. Embodiments of the compression algorithm 110 preferably perform at least one of the following functions (1) speech rate speed up, (2) utterance speed up (3) silence excision, (4) silence speed up, (5) summary excision, (6) summary speed up, (7) insignificant word excision and/or (8) insignificant word speech up.

The transcription engine 106 processes, preferably, each recording or speech data 114 to 118 in the speech corpus 112 to produce at least one of (1) a list of each spoken word within the speech data 114 to 118, (2) a grouping of each word into a single unit called an utterance and (3) a pair of time boundaries for each spoken word or at least an indication of the start and/or end points of each spoken word, utterance or other functional unit or (4) any combination thereof.

The transcripts 120 are preferably stored in a machine readable format such as, for example, XML.

The semantic/acoustic analyser 108 processes the transcription 120 to produce the statistical data 124. The primary purpose of the semantic analysis undertaken by the analyser 108 is to determine an importance score for each word or other functional unit in the transcript. There are many ways in which such an importance score can be determined. However, preferred embodiments use the number of times a term, that is, functional unit of text or speech, appears within a single transcription 120, or set of speech data 114 to 118, multiplied by the inverse frequency of the term appearing in the speech corpus 112 considered as a whole, that is, within the plurality of sets of speech data 114 to 118 or within a selectable plurality thereof. In a preferred embodiment, the importance (imptd) of a term, t appearing in a particular transcript, d, can be calculated by

$${imp}_{td} = \frac{log ( {count}_{td} + 1 )}{log ( {length}_{d} )} \cdot log ( \frac{N}{{N}_{t}} ) ,$$

where imp_{td} represents the importance of a term, t, appearing in the selected speech, d, count_{td} is the frequency with which term t appears in the transcript (or selected speech data) d, length_{d} is the number of unique terms in the speech data d, N corresponds to the number of transcriptions (or the plurality of speech data) and Nₜ is the number of transcriptions that contain the term t.

This formula is preferably applied to all non-stop words. Stop words are non-content bearing words such as “the”, “and”, “is” etc. Stop words are given an importance score of zero. Therefore, the result of the semantic analysis is to produce a mapping, in the form of the statistical data 124, from each word in the transcript 120 to an importance score. In preferred embodiments, this mapping may exist at different levels of granularity. For example, words appearing multiple times in one transcript are given the same importance score. However, embodiments can be realised in which the words are assigned different or respective importance measures.

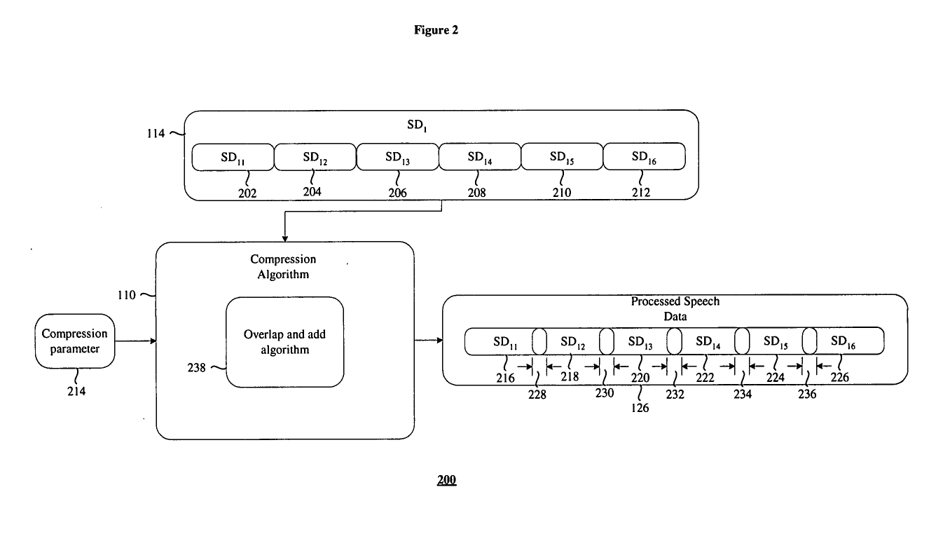

FIG. 2 shows, schematically, processing 200 undertaken by the compression algorithm 110 in relation to the first set of speech data 114. It can be appreciated that the speech data is divided into a plurality of predetermined units of time or segments. In preferred embodiments, each segment has a size of 512 samples. However, embodiments can be realised in which the segments have different sample sizes as compared to the 512 samples or as compared to one another. It can be appreciated in the illustrated embodiment that the speech data 114 has been divided into 6 speech segments 202 to 212.

The speech segments 202 to 212 are arranged to overlap in accordance with a compression parameter 214 to produce the processed speech data 126 comprising a plurality of speech segments 216 to 226 having predeterminable areas of overlap 228 to 236 such that the duration of the overlapping speech segments 216 to 226 meets the compression requirement determined from the compression parameter 214, that is, the processed speech 126 is a compressed representation of the original speech data 114.

Although the above embodiment illustrates six speech segments, embodiments are not limited to such an arrangement. Embodiments can be realised using some other number of speech segments. Furthermore, although the degrees of overlap of each of the overlapping speech segments 216 to 226 are shown as being substantially equal, embodiments are not limited thereto. Embodiments can be realised in which the degrees of overlap of the speech segments 216 to 226 are unequal. In preferred embodiments, the degree of overlap is determined in such a manner as to select points of overlap having predetermined degrees of correlation in an effort to produce seamless transitions between adjacent speech segments.

An overlap and add algorithm 238 undertakes the necessary calculations and manipulations in relation to the segments of speech data 202 to 212 to produce the processed speech data 126 comprising the overlapping segments of speech data 216 to 226.

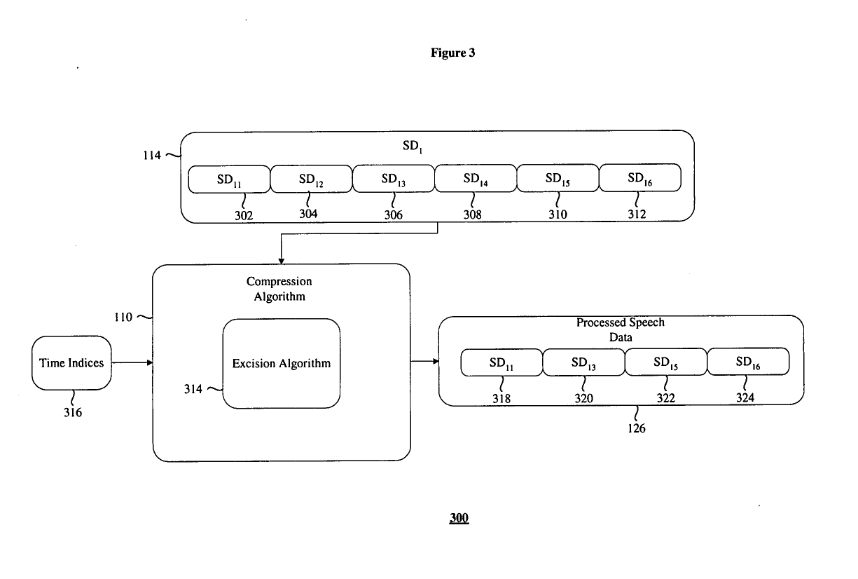

Referring to FIG. 3, there is shown processing 300 undertaken by the compression algorithm 110 in relation to speech data 114 that comprises a number of functional unit such as, for example, speech segments 302 to 312. Although the speech data 114 has been illustrated as comprising a number of segments 302 to 312, embodiments are not limited to such an arrangement. The speech data 114 may merely be continuous speech data or may be divided, equally or otherwise, in some other manner. The compression algorithm 110 comprises an excision algorithm 314 that is responsive to a plurality of time indices 316 that denote sections of time of the speech data 114 to be excised therefrom. It can be appreciated in the illustrated embodiment that the time indices 316 are arranged such that the speech data corresponding to segments 304 and 308 are excised from the speech data 114 to produce the processed speech data 126 comprising the remainder of the speech data 114 after excision. For the purposes of illustration only, it can be appreciated that the processed speech data 126 comprises a plurality of speech segments 318 to 324 that are derived from speech segments 302, 306, 310 and 312 respectively. Therefore, the processed speech data 126 represents a compressed form of the original speech data 114.

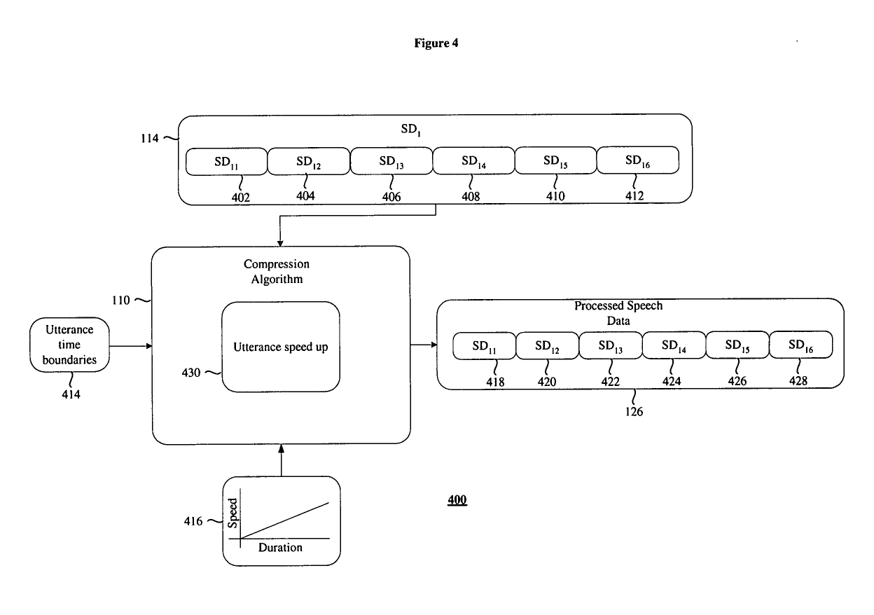

FIG. 4 illustrates a further embodiment processing 400 of a compression algorithm. It can be appreciated that the compression algorithm 110 receives the speech data 114. The speech data 114 comprises a plurality of utterances 402 to 412 that are defined by a plurality of respective utterance time boundaries 414. The utterance time boundaries 414 are produced using the speech data 114 and the transcript 120. An utterance speed up profile 416 is used to create a plurality of speech data 418 to 428 of the processed speech data corresponding to sped up versions of the utterances 402 to 412 respectively of the speech data 114. The sped up utterances 418 to 428 are produced by increasing the speed of playback, or by varying the degree of time compression, according to the profile 416. Suitably, the processed speech data 126 has a duration that is less than the original speech data 114. The necessary processing to achieve the above is undertaken by an utterance speed up algorithm 430.

It can be appreciated that the speed up profile 416 is linear. However, embodiments are not limited to such an arrangement. Embodiments can be realised in which the speed up profile 416 takes some other form such as, for example, a curve. In preferred embodiments, the maximum playback speed of the speed up profile 416 corresponds to 3.5 times real-time. However, other multipliers of the real-time playback speed can be used.

Embodiments can be realised in which the durations of the compressed speech segments 418 to 428 are not all equal. For example, various speed up profiles might be used according to the utterances meeting respective criteria.

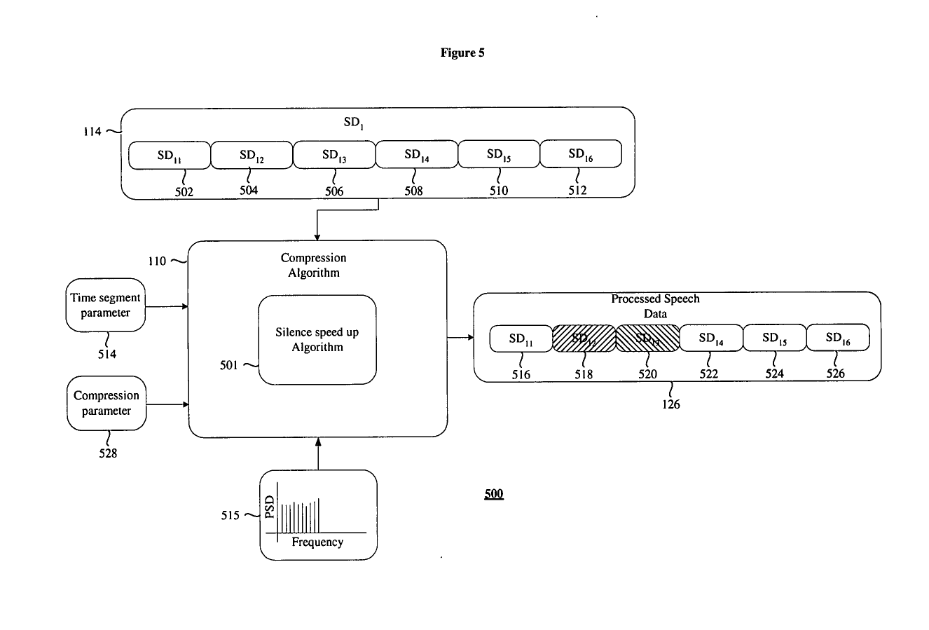

FIG. 5 shows processing 500 of a compression algorithm 510 comprising a silence speed up algorithm 501 for processing the speech data 114. The speech data 114 is split into a plurality of time segments 502 to 512. The size of the time segments is determined via a time segment parameter 514. The time segments have a predetermined duration. In preferred embodiments, the predetermined duration is 30 milliseconds. Still more preferably, the time segments overlap one another by a predetermined amount (not shown). In preferred embodiments, the predetermined amount of overlap corresponds to 5 milliseconds. A 256-point Fast Fourier Transform is calculated for each of the speech segments 502 to 512. Those time segments 502 to 512 of the speech data 114 that correspond to, in effect, silence, that is, do not contain audible utterances, are identified. The identification process can take place manually or automatically. In the case of the identification process being automated, a determination is made as to whether or not a given speech segment 502 to 512 corresponds to silence by examining the respective FFT, that is, power spectrum. This determination as to whether or not a speech segment 502 to 512 comprises silence is made for all of the speech segments. An average FFT is calculated for all of those speech segments 502 to 512 that are deemed to comprise silence. This average is used as an exemplar for determining which of the speech segments 502 to 512 should be at least one of dropped or speeded up if a comparison of the FFT for any given speech segment is comparable with the mean of the FFTs representing silence. It will be appreciated that there are other techniques automating the identification process.

It can be appreciated that the speech segments 504 and 506 are shown via the hatching as speeded up segments of speech data that comprise silence. Accordingly, the processed speech data 126 comprises a plurality of speech data segments 516 to 526 all of which have substantially the same duration as the corresponding speech segments 502 to 512 from which they were derived but for speech segments 518 and 520, which were compressed as the corresponding segments 504 and 506 were deemed to comprise silence when compared with the mean power spectrum 515 of those speech segments deemed to represent silence.

In a preferred embodiment, the determination as to whether or not one of the plurality of speech segments 502 to 512 represents silence uses a Pythagorean distance between the FFT for a given speech segment and the exemplar 515.

Preferably, the speech segments are ordered with reference to their degree of dissimilarity with respect to the silence exemplar 515. An inclusion threshold is then determined so that the cumulative length of the speech segments that are below the inclusion threshold matches that required by a compression parmeter 528. Once the threshold has been determined, time indices are then chosen to correspond with the boundaries of any speech segments 502 to 512 intended to form part of the processed speech data 126. In preferred embodiments the silence speed up algorithm also applies an excision process that includes all speech data segments that are below the threshold, which, thereby, effectively excises most of the silence frames according to the desired compression level.

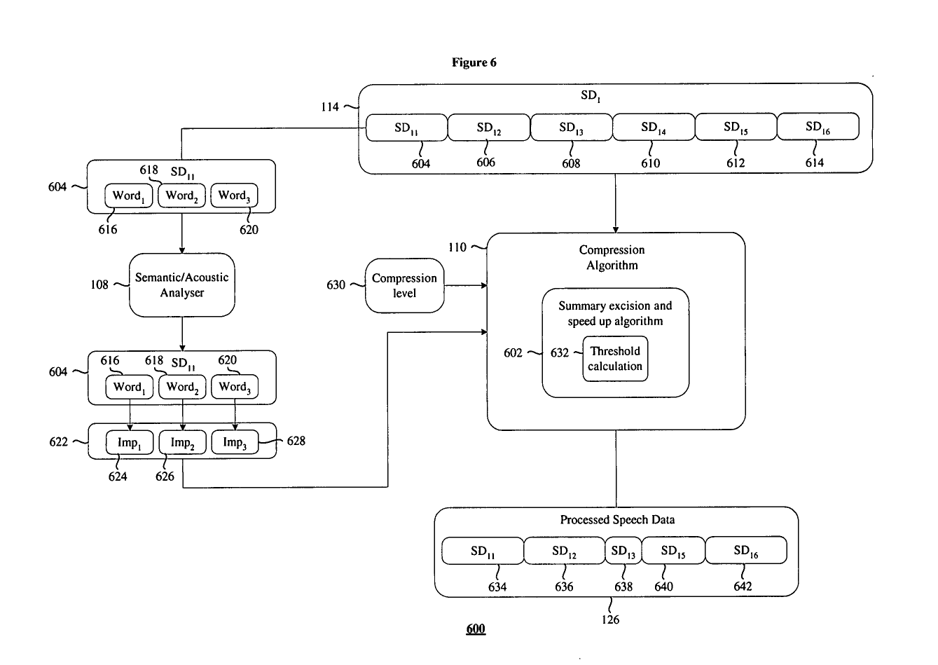

Referring to FIG. 6 there is shown the processing 600 undertaken by the compression algorithm 110 according to a further embodiment. It can be appreciated that the compression algorithm 110 comprises a summary excision and speed up algorithm 602 for processing the plurality of speech data 114 to 118 or selectable data taken from the speech corpus 112. The embodiment shown in FIG. 6 shows only the first set of the speech data 114 for the purposes of clarity. The first set of speech data 114 comprises a plurality of utterances 604 to 614 that are identified from at least one of the transcript 120 corresponding to the first set of speech data 114 and/or from the associated statistical data 124.

The semantic/acoustic analyser 108 is arranged to analyse the speech data 114 with a view to determining an importance score for each utterance. In preferred embodiments, the importance score for each utterance 604 to 614 is calculated from the mean importance of each non-stop word contained within the utterance. This results in a single importance score for each utterance. In the illustrated embodiment, a first utterance 604 of the speech data 114 is illustrated as comprising three words 616 to 620. It can be appreciated that the semantic/acoustic analyser 108 processes the first utterance 604 to produce an overall importance score 622 that is derived from the individual importance scores 624 to 628 of the words 616 to 620 of the first utterance 604. In preferred embodiments, only those words that are not stop words are taken into account when calculating the overall importance score 622.

A desired compression level 630 is supplied to the compression algorithm 110 together with the importance score 622.

It will be appreciated that the processing for determining the importance score 622 for the first utteranc 604 of the speech data 114 is preferably performed for all utterances contained within the speech data 114. Alternatively, any such processing might be undertaken for selective utterances. Furthermore, it can be appreciated that determining an importance score for each utterance of the speech data 114 has been undertaken for the first set of speech data 114. However, embodiments are not limited thereto. Embodiments can be realised in which any selected speech data of the plurality of sets of speech data 114 to 118 contained with the speech corpus 112 could have been selected for processing. Still further, any combination of those sets of speech data 114 to 118 could have been selected for processing.

The compression algorithm 110 and, more particularly, the summary excision and speed up algorithm 602, computes respective thresholds for speed up and excision via a threshold calculator 632.

The utterances are ranked in order of importance for progressive inclusion in, or to progressively create, the processed speech data 126 until the processed speech data 126 has a length that is determined by the compression level 630. It can be appreciated that the illustrated processed speech data 126 comprises a plurality of utterances 634 to 642 that are respectively derived from all utterances 604 to 614 of the speech data 114 with the exception of the fourth utteranc 610, which is assumed to have been insufficiently important to justify being included within the processed speech data. Therefore, the fourth utteranc 610 was excised. It can also be appreciated that the third utteranc 608 was deemed to be sufficiently important to be included within the processed speech data 106 but insufficiently important to be played back at normal playback speed, that is, to be played back in real time. Accordingly, that utterance has been compressed or speeded up using, for example, one of the speed up techniques described above.

Although the present embodiment comprises a summary excision and speed up algorithm, embodiments are not limited to such an arrangement. The excision and speed up may be performed independently of one another.

The performance of the various embodiments of the present invention has been investigated in a comparative study as can be appreciated from, for example, “Time is of the essence: An Evaluation of Temporal Compression Algorithms”, Tucker, S., Whittaker, S. CHI 2006, Apr. 22-28, Montreal, Québec, Canada and “Novel Techniques for Time-Compressing Speech: An exploratory Study”, Tucker, S., Whittaker, S, both of which are incorporated by reference herein for all purposes and included in the appendix.

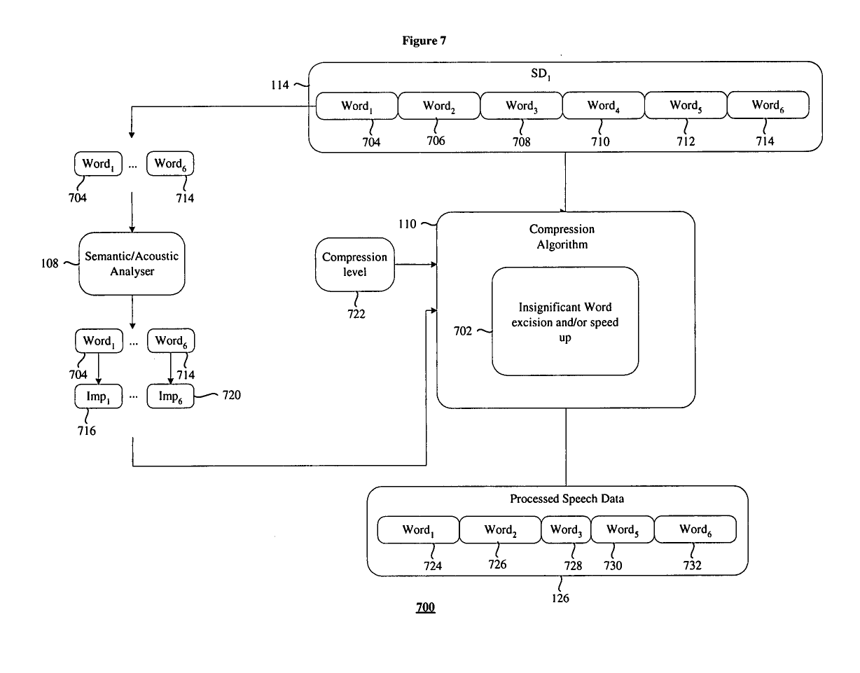

Referring to FIG. 7, there is shown the processing 700 undertaken by the compression algorithm 110, which comprises a significant word excision and/or speed up algorithm 702. This embodiment is substantially similar to the above embodiment describing summary excision and/or speed up. However, rather than computing an importance measure for each utterance, the importance measures for each word indicated above and described with reference to FIG. 1 is used in determining whether or not a word should be included within the processed speech 126.

It can be appreciated that, again, only the first set of speech data 114 has been illustrated in FIG. 7 even though any or all combinations of the speech data 114 to 118 contained within the speech corpus 112 could be selected for processing according to the embodiment. The speech data 114 is illustrated as comprising a plurality of words 704 to 714. As indicated earlier, an importance score is calculated for each of the words 704 to 714 via the semantic/acoustic analyser 108 to determine associated importance scores 716 to 720.

The importance scores 716 to 720 are used in conjunction with a desired compression level 722 by the compression algorithm 110 and, more particularly, the insignificant word excision and/or speed up algorithm 702, to determine which words 704 to 714 of the speech data 114 should be included in , or used to create, the processed speech data 126. The decision as to whether or not to include one of the plurality of words 704 to 714 within the processed speech data 126, that is, to create the processed speech data 126, is determined by ranking the words 704 to 714 according to their respective importance metrics 716 to 720 and progressively including words within the processed speech data according to those rankings. It will be appreciated that some words may be sufficiently unimportant to be deemed unnecessary, that is, they will not be included in the processed speech data 126. Referring to the processed speech data 126, it can be appreciated that it comprises a plurality of words 724 to 732 that are derived from respective words 704 to 714 of the speech data 114 but for the fourth word 710 which is deemed to be sufficiently unimportant not to merit inclusion within the processed speech data 126. Furthermore, it can also be appreciated that the third 708 and fifth 712 words of the speech data 114 had respective importance levels to merit being speeded up by respective amounts. It will be appreciated that a plurality of importance threshold levels can be used to determine the respective amounts by which words falling within bounds defined by such a plurality of importance threshold levels are speeded up.

Although the above embodiment comprises an insignificant word excision and speed up algorithm, embodiments are not limited to such an arrangement. Embodiments can be realised in which insignificant word excision and insignificant word speed up are implemented severally as opposed to jointly in the illustrated embodiment.

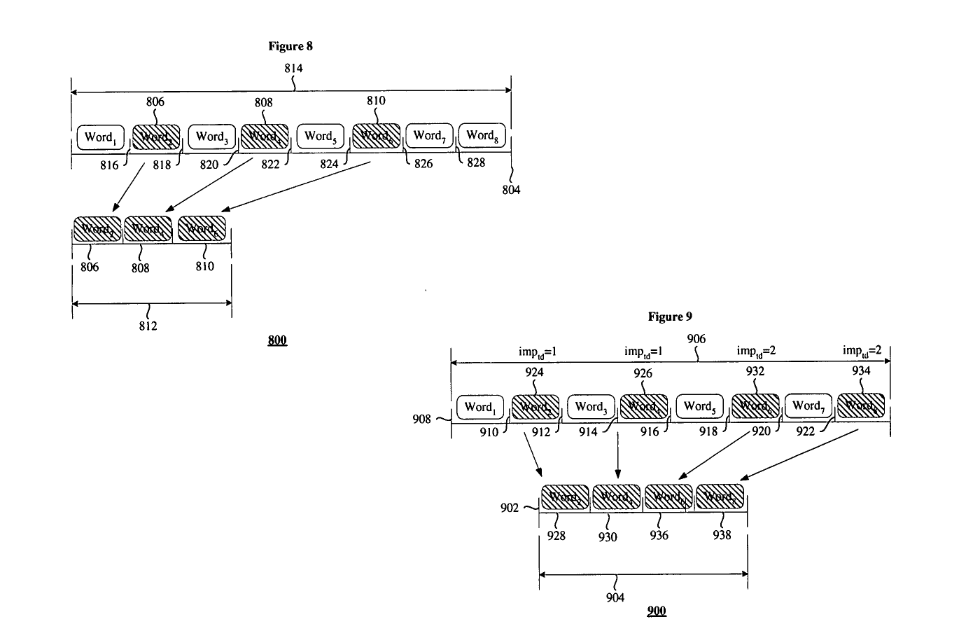

Referring to FIG. 8 there is shown an example 800 of processing undertaken by the above embodiments when creating a speech file 802 sufficient to provide a gist of understanding of the content of the native speech file 804. It can be appreciated that the native speech file comprises a plurality of words, Word₁ to Word₈. Although this embodiment will be described with reference to the functional units being words, embodiments are not limited to such an arrangement. Embodiments can be realised in which the functional units correspond to units other than words. For example, the functional units may be utterances, phrases, clauses, sentences or some other convenient unit into which the speech data can be divided. It can be appreciated that three words 806, 808 and 810 have been identified as having a sufficient degree of importance to merit being included in the created speech file 802.

The way in which the speech file 802 is created is as follows. A threshold against which importance of the words Word₁ to Word₈ can be measured is selected. A pass is performed through the first set of speech data 804 to determine whether or not the words contained therein have respective importance measures that are above or below the threshold, that is, to determine whether or not the words are sufficiently important to merit being included in the created speech file 802. If the words do have sufficient importance, they are included in the created speech file 802.

In the present example, it can be appreciated that the three words 806 to 810 have been included in the created speech file 802. As a first step in creating the speech file 802, its duration 812 is selected. The duration 812 can be merely a specified time. Alternatively, the duration 812 can be expressed as having some relationship with the duration 814 of the original set of speech data 804. For example, the duration 812 of the created speech data 802 may be set to be 33% of the duration 814 of the original data 804. It will be appreciated that any relationship between the duration 812 of the created speech file 802 and the duration 814 of the original speech 804 can be used.

During the pre-processing phase described above with reference to FIG. 1, each word has associated time boundaries such as, for example, time boundaries 816 to 828. The process of selecting an importance threshold and traversing the original set of speech data 804 to identify words or some other functional unit of the original speech data 804 to form part of the created speech file 802 is repeated if a pass through the original data 804 shows that there are insufficient functional units having respective importance metrics that meet the threshold to achieve the specified duration 812 of the created speech 802. Therefore, it can be appreciated that multiple passes through the original data 804 may be required.

An example of such processing 900 is described with reference to FIG. 9. It can be appreciated that the speech file 902 to be created has a respective duration 904 which can be, for example, expressed as some percentage of the duration 906 of original speech data 908. The original data 908 is shown as comprising a plurality of functional units that, for the purposes of illustration only, have been expressed as words, that is, Word₁ to Word₈. Each of the words has respective time boundaries 910 to 922. Assume that an importance threshold of imp_{td}=1 is selected for the first pass. It can be appreciated that two words 924 and 926 are indicated as having an importance of imp_{td}=1. Therefore, those two words 924 and 926 are included in the created speech file 902 as respective portions 928 and 930 of speech defined by their respective time boundaries 910, 912, 914 and 916. However, it can be appreciated that the duration of the two words, Word₂ and Word4 is insufficient to construct a speech file having the specified duration 904. Suitably, the importance threshold is changed, that is, it is lowered in the present embodiment, and the pass through the original speech data 908 is undertaken again. In the second pass, as well as including words Word₂ and Word4 in the created speech file 902, it can be appreciated that the sixth and eighth words 932 and 934 are also included in created speech file 902 via respective portions 936 and 938 since they have respective importances of two. By way of a further example, if the eighth word 934 had an importance of, for example, three, it can be appreciated that the three previously selected words 924, 926 and 932 would, having concatenated their respective speech portions 928, 930 and 936, be insufficient to create the speech file 902 having the specified duration 904. Accordingly, a further pass through the original data 908 using an importance threshold of imp_{td}=3 would be required. Therefore, it can be appreciated that the speech files are progressively created by identifying data having an appropriate level of importance to merit being included within the speech file.

In alternative embodiments, the words not selected for inclusion in the created speech files in the above embodiments described with reference to FIGS. 8 and 9 can be merely rejected or included in the speech files in a modified form. For example, the unimportant words can be speeded up or excised.

It can be appreciated from the above that determining the relative importance of the various parts of speech allows a file to be created that is able to provide an indication of the content of that file without having to play the whole of the file. One skilled in the art understands that data relating to the relative importance of the various functional units is an embodiment of correlated redundancy data. Embodiments can be realised in which the important functional units are selected for inclusion in the created speech file using. Alternatively, or additionally, embodiments can be realised that excise from an existing speech file functional units that are insufficiently important to merit remaining.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A speech processing system comprising a data base manager to access a speech corpus comprising a plurality of sets of speech data; means for processing a selectable set of speech data to produce correlated redundancy data and means for creating a speech file comprising speech data according to the correlated redundancy data having a playback speed other than the normal playback speed of the selected speech data.

2. A system as claimed in claim 1 in which the means for processing the selected speech data comprises a transcription engine to create a transcript to identify at least one corresponding functional unit of speech.

3. A system as claimed in claim 2 in which the functional unit of speech comprises at least one of an utterance, a word, clause, phrase, sentence or paragraph.

4. A system as claimed in claim, further comprising means to identify boundaries between the functional units of speech.

5. A system as claimed in claim 2, further comprising a semantic analyser for determining a metric associated with the at least one corresponding functional unit of speech.

6. A system as claimed in claim 5 in which the metric reflects the degree of importance of the at least one corresponding functional unit within the context of the selected speech data.

7. A system as claimed in claim 6 in which the metric is derived from at least one of (1) the frequency of the at least one corresponding functional unit within the selected speech data and (2) the inverse frequency of the at least one corresponding functional unit within the speech corpus.

8. A system as claimed in claim 7 in which the metric is calculated using
$${imp}_{td} = \frac{log ( {count}_{td} + 1 )}{log ( {length}_{d} )} \cdot log ( \frac{N}{{N}_{t}} ) ,$$
where imp_{td} represents the importance of a term, t, appearing in the selected speech, d, count_{td} is the frequency with which term t appears in the transcript (or selected speech data) d, length_{d} is the number of unique terms in the speech data d, N corresponds to number of transcription (or the plurality of speech data) and Nₜ is the number of transcriptions that contain the term t.

9. A system as claimed in claim 2, further comprising means overlap selectable units of the selected speech data to produce a reduced playback time as compared to the playback time of the speech data.

10. A system as claimed in claim 9 in which the means to overlap the selectable units of the speech data comprise means to calculate at least one overlap position for the selectable units of speech data to achieve a predetermined degree of correlation between overlapping units of speech data.

11. A system as claimed in claim 10 wherein the selectable units of speech data are associated with selected boundaries of said identified boundaries.

12. A system as claimed in claim 2, further comprising an excise means to excise selected units of the selected speech.

13. A system as claimed in claim 12 in which the excise means comprising means to excise selected units of the selected speech data comprises means to excise those parts of the selected speech data not corresponding to audible utterances.

14. A system as claimed in claim 12 in which excise means comprising means to excise the selected units of speech comprises means to divide the selected speech data into predetermined units of time.

15. A system as claimed in claim 13, further comprising a spectrum analyser to calculate a power spectrum for speech data corresponding to least selected predetermined units of time to identify those parts of the selected speech data not corresponding to audible utterances.

16. A system as claimed in claim 15, further comprising means to determine an exemplar reflecting an average of those parts of the selected speech data not corresponding to audible utterances for the selected speech data.

17. A system as claimed in claim 16, further comprising means to determine predetermined degrees of correlation exists between the predetermined units of time of the selected speech data and the exemplar.

18. A system as claimed in claim 16 in which the means to create the speech file comprises including in the speech file speech data corresponding to those predetermined units of time of the selected speech data having progressively increasing degrees of predetermined correlation.

19. A system as claimed in claim 18 in which the means to create the speech file comprising means to include in the speech file speech data corresponding to those predetermined units of time of the selected speech data having progressively increasing degrees of predetermined correlation comprises means to include in the speech file speech data corresponding to those predetermined units of time of the selected speech data having progressively increasing degrees of predetermined correlation commencing with those predetermined units of time of the selected speech data having a particular threshold of degree of correlation.

20. A system as claimed in claim 19 in which those predetermined units of time of the selected speech data having a particular threshold of degree of correlative comprises those predetermined units of time of the selected speech data having the lowest of degree of correlation.

21. A system as claimed in claim 20, further comprising means to mark selected predetermined units of units of time of the selected speech data for playback at a predetermined playback speed.

22. A system as claimed in claim 21 in which the predetermined playback speed is substantially normal speed where the selected predetermined units of time of the selected speech data have a selected degree of correlation.

23. A system as claimed in claim 1, further comprising means to identify speech data corresponding to the boundaries and in which the means to create the speech file comprises means to process at least selected speech data corresponding to the boundaries such that the playback speed of the speech data corresponding to the boundaries varies according to a predetermined profile over the duration of the speech data corresponding to the boundaries.

24. A system as claimed in claim 23 in which the playback speed is less than or equal to a predetermined playback speed.

25. A system as claimed in claim 24 in which the playback speed is less than or equal to 3.5 times the normal playback speed.

26. A system as claimed in claim 23 in which the predetermine profile is a linearly increasing profile.

27. A system as claimed in claim 23 in which the predetermined profile influences the playback duration of the speech data corresponding to the boundaries.

28. A system as claimed in claim 2, further comprising means to produce a plurality of extractive summaries having respective lengths using a plurality of said at least one corresponding functional unit of speech.

29. A system as claimed in claim 28, further comprising means to rank the functional unit of speech according to the number of extractive summaries containing the functional units of speech such that ranking varies with the length of the extractive summaries.

30. A system as claimed in claim 29 in which the ranking of a functional unit of speech increases with decrease extractive summary length.

31. A system as claimed in claim 29 in which the means to create the speech file comprises means to include within the speech file speech data corresponding to selected ones of the plurality of said at least one corresponding functional unit of speech according to said ranking.

32. A system as claimed in claims claim 29 in which the means to create the speech file comprises means to excise from the selected speech data speech data corresponding to selected one of the plurality of said at least one corresponding functional units of speech according to said ranking.

33. A system as claimed in claim 1, wherein the at least one functional unit comprise a plurality of words and the system further comprises means to calculate a respective metric for each of the words; the metrics being related to the frequency of use of the words in at least one of the selected speech data and the speech corpus.

34. A system as claimed in claim 33 in which the means for creating the speech file comprises including within the speech file speech data corresponding to words, said including being performed according to the respective metrics of the words until the speech file comprises speech data having a predetermined playback duration.

35. A system as claimed in claim 33 and in which the means to calculate a respective measure for each of the words comprises means to determine at least one of the frequency of use of the words in the speech corpus and the frequency of use of the words in the selected speech data and means to use those frequencies in calculating the measure.

36. A system as claimed in claim 35 in which the measure is calculated using the frequency of the words in the selected speech data over the frequency of the words used in the speech corpus.
